(19) United States
(12) Patent Application Publication
(10) Pub. No.: US 2017/0168797 A1
(43) Pub. Date: Jun. 15, 2017

(54) MODEL-DRIVEN UPDATES DISTRIBUTED TO CHANGING TOPOLOGIES

(71) Applicant: Microsoft Technology Licensing, LLC, Redmond, WA (US)

(72) Inventor: Vladimir Pogrebinsky, Redmond, WA (US)

(21) Appl. No.: 14/964,222

(22) Filed: Dec. 9, 2015

(51) Int. Cl. G06F 9/445

(52) U.S. Cl. CPC G06F 8/65

(57) ABSTRACT

Examples of the disclosure enable updates to be deployed to a modifiable distributed topology. In one aspect, a computer-implemented method, system, and computer storage medium for distributing model-driven updates are provided. An instruction to define a task is received. A model defining a first instance of a plurality of components for a distributed cloud application is received, the plurality of components including a first component and an update component. The first instance of the plurality of components is deployed. The update component determines whether an update to the distributed cloud application is available. In response to determining that the update is available, a second template associated with the update is retrieved, with the second template defining a second instance of the first component. The second instance of the first component is deployed.

### BACKGROUND

Software updates have traditionally been utilized to fix defects, improve security, and introduce new features. Distributing software updates typically involves deploying updates on a per-device basis. However, many modern computing environments are cloud-based, and feature a wide variety of operating systems, software, device configurations, etc.

Known cloud computing devices provide a variety of computing, networking, and/or storage services over a network (e.g., the Internet). Cloud services may be available, for example, at a remote computing device coupled to the network. From a client perspective, cloud services appear to be provided from a single source (e.g., the “Cloud”). However, applications and programs that are implemented to provide cloud services may be distributed across a plurality of resources (e.g., databases, servers, virtual machines). Updates targeting a single machine are not suitable for distributed environments, which typically require customized configuration, and often access privileges, in order to be successfully applied.

### SUMMARY

Examples of the disclosure enable the deployment of model-driven updates in an efficient and effective manner. In some examples, a model defining a first instance of a plurality of components for a distributed cloud application is received, and the first instance of the plurality of components is deployed. The plurality of components includes a first component and an update component. It may be determined whether an update to the distributed cloud application is available. On condition that an update is available, a second template associated with the update is retrieved. The second template defines a second instance of the first component. The second instance of the first component may be deployed to provide a model-driven update.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of an example cloud-computing environment.

FIG. 2 is a block diagram of an example cloud system and an example mobile device in an environment, such as the cloud-computing environment shown in FIG. 1.

FIG. 3 is a block diagram of an example operating environment for deploying an updated template to a cloud component.

FIG. 4 is a flowchart of an example method for deploying an updated template to a cloud component.

FIG. 5 is a flowchart of an example method for managing updates with a distribution ring.

FIG. 6 is a flowchart of an example method for dependency updating within a template.

FIG. 7 is a block diagram of an example computing device that may be used to deploy an updated template to a cloud component.

Corresponding reference characters indicate corresponding parts throughout the drawings.

### DETAILED DESCRIPTION

The subject matter described herein is related generally to the management of cloud services and, more particularly, to deploying an updated template to a cloud component. Some examples provide for receiving a model defining a first instance of a plurality of components for a distributed cloud application, wherein the plurality of components includes a first component and an update component. The first instance of the plurality of components may be deployed. In some examples, the update component determines whether an update to the distributed cloud application is available, and, if the update is available, retrieves a second template associated with the update, wherein the second template defines a second instance of the first component. Some examples provide for deploying the second instance of the first component.

The examples described herein enable model-driven distributed updates to be managed in a modifiable topology. For example, the examples described herein provide a cloud application including a template that provides updates to components of the cloud application and/or allows for adding and/or removing the components. The examples described herein may be implemented using computer programming or engineering techniques including computing software, firmware, hardware, or a combination or subset thereof. Aspects of the disclosure enable an update to one or more components to be discovered and deployed across a distributed network in a calculated and systematic manner for increased performance. One aspect provides for updating components utilizing different tiers of cloud resources that are accessible to different tiers of users. Another aspect provides for managing which updates are applied to components in a template, such as within a distribution ring. For example, a condition based upon the stability and/or adoption history of an update may use a threshold to restrict which updates are allowed to proceed. Yet another aspect provides for propagating a configuration change between components. For example, a change in one component, such as a database password, may be propagated so that the change is made to other components within the template without having to manually make the change in the other components. The methods and systems described herein facilitate deploying one or more updates across a distributed environment.

As described above, at least one technical problem known with providing updates in cloud computing environments involves applying updates to multiple machines or resources within multi-tenant environments, such as with a group or tier of users that are utilizing a variety of machines or resources within a given cloud computing environment. The systems, methods, and media described herein address other technical problems as well. For example, by providing a uniform, model-driven environment for a distributed application to receive updates, without making assumptions about the structure or topology (the structure of the components and/or resources in a cloud computing environment) of the cloud application, the updates may be applied more efficiently and accurately than otherwise possible. Such updates have traditionally been applied on machine-by-machine (or resource-by-resource) basis, which is not a practical approach in a cloud computing environment where various machines or resources are utilized, and the machines or resources being utilized change over time. Another aspect of the systems, methods, and media described herein increases cloud application stability and security through a distribution ring. For example, new updates and/or problematic updates may break functionality, compromise security, and/or lead to latent problems. Providing a mechanism that controls which updates are applied thereby improves application and machine functionality, speed, efficiency, and security. Another aspect of the systems, methods, and media described herein updates dependencies between components. By propagating information that creates dependencies between components in a cloud application, the efficiency, security, dependability, speed, and accuracy of an application may be greatly improved. For example, if a separate system such as a database requires a periodic password update, then automatically propagating the change made to one component, among the various components within a cloud application, avoids the problems of having connections and automatic log-ins inadvertently (and periodically) broken.

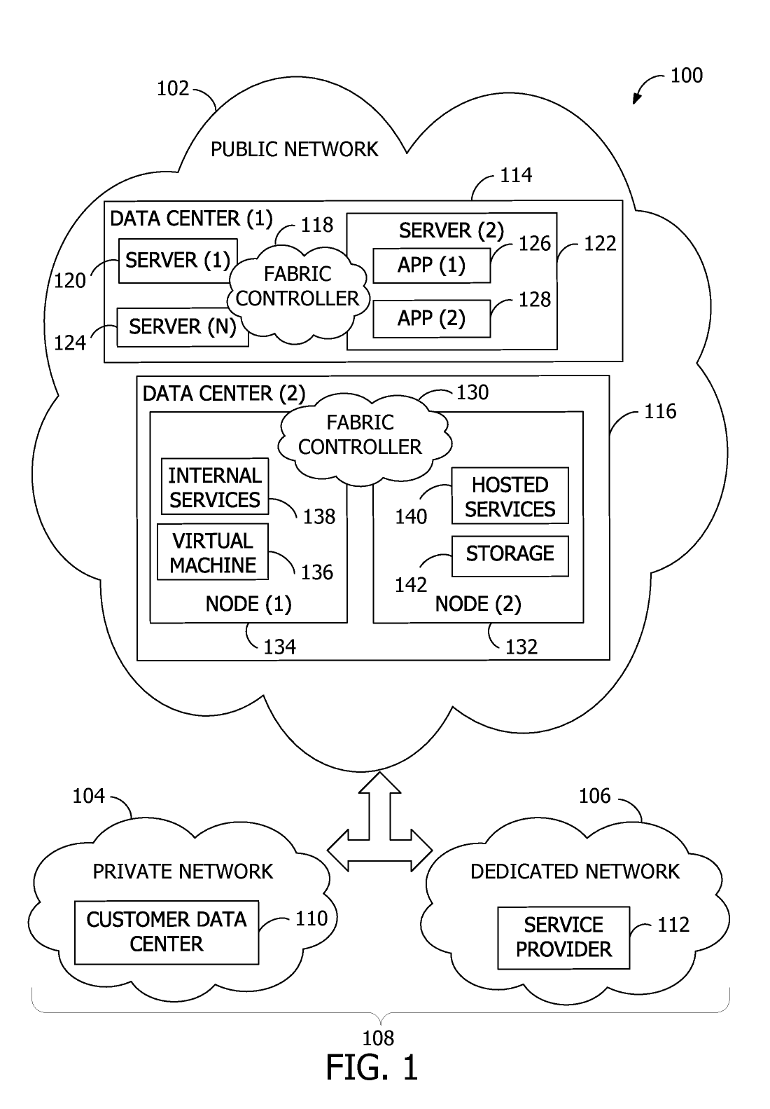

FIG. 1 is a block diagram illustrating an example cloud-computing environment for deploying an application or “app” (e.g., web app, mobile app, logic app, application programming interface (API) app). Architecture 100 illustrates an example cloud-computing infrastructure, suitable for use in implementing aspects of the disclosure. Architecture 100 should not be interpreted as having any dependency or requirement related to any single component or combination of components illustrated therein. In addition, any number of nodes, virtual machines, data centers, role instances, or combinations thereof may be employed to achieve the desired functionality within the scope of examples of the present disclosure.

The distributed computing environment of FIG. 1 includes a public network 102, a private network 104, and a dedicated network 106. Public network 102 may be a public cloud, for example. Private network 104 may be a private enterprise network or private cloud, while dedicated network 106 may be a third party network or dedicated cloud. In this example, private network 104 may host a customer data center 110, and dedicated network 106 may host an internet service provider 112. Hybrid cloud 108 may include any combination of public network 102, private network 104, and dedicated network 106. For example, dedicated network 106 may be optional, with hybrid cloud 108 that includes public network 102 and private network 104.

Public network 102 may include data centers configured to host and support operations, including tasks of a distributed application, according to the fabric controller 118. It will be understood and appreciated that data center 114 and data center 116 shown in FIG. 1 is merely an example of one suitable implementation for accommodating one or more distributed applications and is not intended to suggest any limitation as to the scope of use or functionality of examples of the present disclosure. Neither should data center 114 and data center 116 be interpreted as having any dependency or requirement related to any single resource, combination of resources, combination of servers (e.g. server 120, server 122, and server 124) combination of nodes (e.g., nodes 132 and 134), or set of APIs to access the resources, servers, and/or nodes.

Data center 114 illustrates a data center including a plurality of servers, such as server 120, server 122, and server 124. A fabric controller 118 is responsible for automatically managing the servers and distributing tasks and other resources within the data center 114. By way of example, the fabric controller 118 may rely on a service model (e.g., designed by a customer that owns the distributed application) to provide guidance on how, where, and when to configure server 122 and how, where, and when to place application 126 and application 128 thereon. In one example, one or more role instances of a distributed application, may be placed on one or more of the servers of data center 114, where the one or more role instances may represent the portions of software, component programs, or instances of roles that participate in the distributed application. In another example, one or more of the role instances may represent stored data that is accessible to the distributed application.

Data center 116 illustrates a data center including a plurality of nodes, such as node 132 and node 134. One or more virtual machines may run on nodes of data center 116, such as virtual machine 136 of node 134, for example. Although FIG. 1 depicts a single virtual node on a single node of data center 116, any number of virtual nodes may be implemented on any number of nodes of the data center in accordance with illustrative examples of the disclosure. Generally, virtual machine 136 is allocated to role instances of a distributed application, or service application, based on demands (e.g., amount of processing load) placed on the distributed application. As used herein, the phrase “virtual machine” is not meant to be limiting, and may refer to any software, application, operating system, or program that is executed by a processing unit to underlie the functionality of the role instances allocated thereto. Further, the virtual machine 136 may include processing capacity, storage locations, and other assets within the data center 116 to properly support the allocated role instances.

In operation, the virtual machines are dynamically assigned resources on a first node and second node of the data center, and endpoints (e.g., the role instances) are dynamically placed on the virtual machines to satisfy the current processing load. In one instance, a fabric controller 130 is responsible for automatically managing the virtual machines running on the nodes of data center 116 and for placing the role instances and other resources (e.g., software components) within the data center 116. By way of example, the fabric controller 130 may rely on a service model (e.g., designed by a customer that owns the service application) to provide guidance on how, where, and when to configure the virtual machines, such as virtual machine 136, and how, where, and when to place the role instances thereon.

As discussed above, the virtual machines may be dynamically established and configured within one or more nodes of a data center. As illustrated herein, node 132 and node 134 may be any form of computing devices, such as, for example, a personal computer, a desktop computer, a laptop computer, a mobile device, a consumer electronic device, server(s), and the like. In one instance, the nodes host and support the operations of the virtual machines, while simultaneously hosting other virtual machines carved out for supporting other tenants of the data center 116, such as internal services 138, hosted services 140, and storage 142. Examples of storage 142 may include, but are not limited to, flash storage, hard disk, flash controller, array-based memory, RAID, solid-state drive (SSD), hybrid hard disk drive (HDD), array, flash array, and solid state drive (SSD) RAID.

Often, the role instances may include endpoints of distinct service applications owned by different customers.

Typically, each of the nodes include, or is linked to, some form of a computing unit (e.g., central processing unit, microprocessor, etc.) to support operations of the component(s) running thereon. As utilized herein, the phrase “computing unit” generally refers to a dedicated computing device with processing power and storage memory, which supports operating software that underlies the execution of software, applications, and computer programs thereon. In one instance, the computing unit is configured with tangible hardware elements, or machines, that are integral, or operably coupled, to the nodes to enable each device to perform a variety of processes and operations. In another instance, the computing unit may encompass a processor (not shown) coupled to the computer-readable medium (e.g., computer storage media and communication media) accommodated by each of the nodes.

The role instances that reside on the nodes support operation of service applications, and may be interconnected via APIs. In one instance, one or more of these interconnections may be established via a network cloud, such as public network 102. The network cloud serves to interconnect resources, such as the role instances, which may be distributed across various physical hosts, such as nodes 132 and 134. In addition, the network cloud facilitates communication over channels connecting the role instances of the service applications running in the data center 116. By way of example, the network cloud may include, without limitation, one or more personal area networks (PANs), one or more local area networks (LANs), one or more wide area networks (WANs), and/or one or more cellular or mobile networks. Such networking environments are commonplace in offices, enterprise-wide computer networks, intranets, and the Internet.

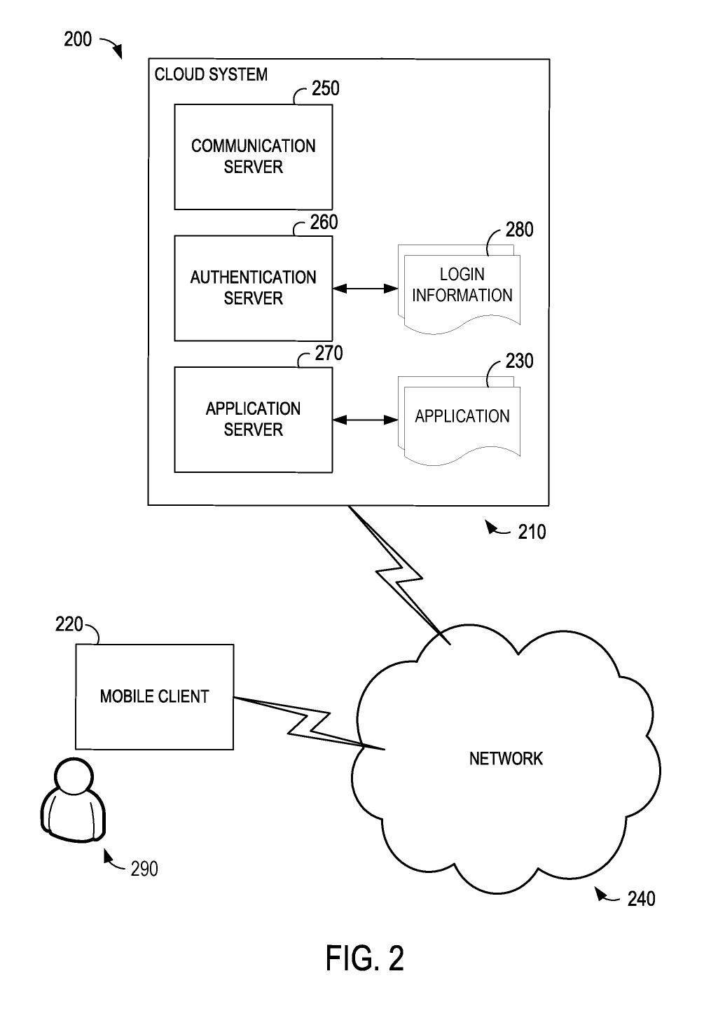

FIG. 2 is a block diagram of an example environment 200 including a cloud system 210 and a mobile device or mobile client 220 coupled to the cloud system 210. The mobile client 220 may, for example, communicate with the cloud system 210 to access one or more applications. In some examples, the environment 200 includes one or more cloud systems 210, and the mobile client 220 may be coupled to the one or more cloud systems 210 via one or more networks 240 (e.g., public network 102, private network 104, dedicated network 106).

The cloud system 210 is configured to perform one or more operations. For example, the cloud system 210 may include and/or have access to a communication server 250, an authentication server 260, and/or an application server 270. In some examples, the communication server 250 is configured to control communication (e.g., data flow) between one or more computing devices (e.g., cloud system 210, communication server 250, authentication server 260, application server 270) and the mobile client 220. Communication between the one or more computing devices and the mobile client 220 may occur using any protocol or mechanism over any wired or wireless connection. For example, the one or more computing devices may communicate with the mobile client 220 via the network 240.

The mobile client 220 may initiate a request to the cloud system 210 (e.g., via the communication server 250) to access one or more applications 230 hosted on and/or by the cloud system 210. For example, the mobile client 220 may access data associated with the cloud system 210 to perform one or more operations. In some examples, the authentication server 260 is configured to manage, store, and/or have access to registered login information 280 (e.g., identification, password), and, based on the registered login information 280, determine whether the mobile client 220 or a user 290 associated with the mobile client 220 is authorized to access data associated with the cloud system 210. The authentication server 260 may receive user input (e.g., identification, password) from the mobile client 220 (e.g., via the communication server 250), and compare the received user input with the registered login information 280 to determine whether the mobile client 220 or user 290 is authorized to access data associated with the cloud system 210. In some examples, the mobile client 220 and/or user 290 may be authorized to access (or be restricted from accessing) one or more computing devices and/or perform one or more operations based on a role associated with the mobile client 220 and/or user 290 (e.g., administrator, author, user, writer, reader, parent, child).

In some examples, the application server 270 is configured to manage and/or store one or more applications 230 and communicate with the mobile client 220 (e.g., via the communication server 250) to allow the user 290 to access one or more applications 230 using the mobile client 220. The application 230 may be configured to perform one or more operations and may include any combination of computing software, firmware, hardware, or a combination or subset thereof. For example, the application 230 may be configured to present an image or a series of images (e.g., a video) on a display, play audio, and/or send a service call to access data associated with another computing device (e.g., cloud system 210).

An application 230, when executed by a processor, operates to perform a functionality. An application 230 may communicate with other applications or services, such as web services accessible via the network 240. For example, an application 230 may represent a downloaded client-side application that corresponds to server-side services executing at the cloud system 210. In some examples, applications 230 may be configured to communicate with the cloud system 210 during runtime, or may share and/or aggregate data between client-side services and cloud services.

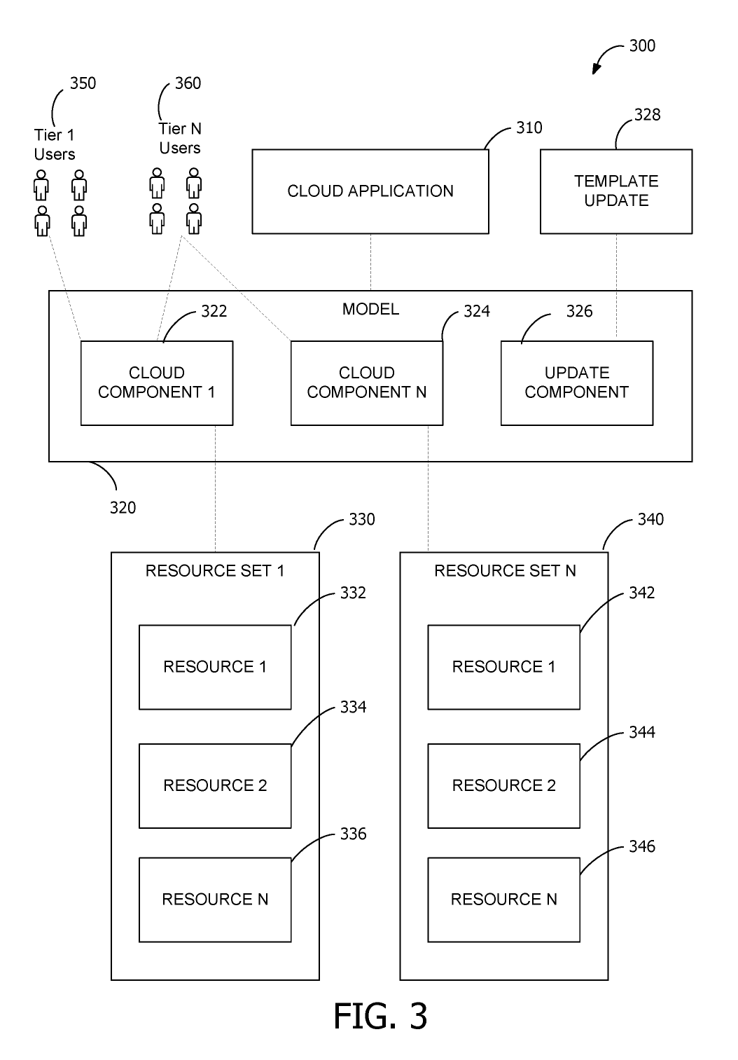

FIG. 3 is a block diagram illustrating an example of an operating environment 300. The examples herein may be implemented in any type of cloud hosting environment. For example, the cloud hosting environment may provide public cloud hosting that does not require a user to host any cloud infrastructure. As another example, the cloud hosting environment may provide for self-hosting a cloud infrastructure as a private cloud.

A cloud application 310 (e.g., application 230) may be any type of program utilizing a cloud-based architecture. A cloud application 310 may provide the interactivity of a client-side program that avoids consuming a user's local resources, while providing superior interaction to a traditional web application, thus providing a more seamless and portable experience.

A model 320 may be used as a model with respect to one or more cloud applications 310 to distribute a variety of data, including updates, on a declarative topology, such as an explicit model defined with JSON (JAVASCRIPT® Object Notation; JAVASCRIPT is a registered trademark of Oracle America, Inc.) or any other suitable format and/or programming language. The terms ‘template’ and ‘model’ may be used interchangeably. The model 320 may define the topology (or structure) of the cloud application 310. The model 320 may include any number of components 322, 324, along with any number of update components 326. In some examples, a combination of components 322, 324 may be added and/or removed from the model 320. A component may be user-controlled, configurable, exhibit well-defined behavior, implement functionality, and/or utilize various resources. An update component may receive and/or request updates, such a template update 328.

Resources 332, 334, and 336 and 342, 344, and 346 may belong to resource sets 330, 340, respectively. A resource may be any type of machine, network, server, virtual machine, software application, and/or service. Providers of resources (or ‘resource providers’) include, for example, structured query language (SQL) providers, website providers, computing resource providers, etc., which may be obtained, for example, from a representational state transfer (REST) API. Resources may also have default values that will specify that input is required.

A resource need not be located in physical proximity to other resources being hosted in the cloud infrastructure. By grouping resources into resource sets, resources 332, 334, 336 are within a resource set 330 that may be utilized as a logical group by a component, regardless of the actual location of any of the resources. Any cloud component may be granted access (e.g., read-only, execution, administrative, audit) to any number of resource sets and/or resources. Such access may be modified upon the updating of a template or component. In some examples, the template may be modified by adding/removing resources from a particular cloud computing environment. This, in turn, may be represented (or caused by) changes in the template/model.

Differing tiers (or groups) of users 350, 360 may utilize different components 322, 324. A tier of users may contain any number of users, including no users or one user. Moreover, the number of users contained in any tier may vary at any time. Tiers of users need not necessarily have mutually exclusive access with respect to each other for components, resource groups, and/or resources. Tiers may connote ranking or precedence (such as access or privileges), but need not necessarily. As an illustration, Tier 1 users 350 are provided access to component 1 322 through which access to resource set 1 330 (and constituent resources 332, 334, 336) is provided. By contrast, continuing with this example, tier N users 360 are provided access to component 1 322, through which access to resource set 1 330 (and constituent resources 332, 334, 336) is granted, as well as access to component N 324 through which access to resource set N 340 (and constituent resources 332, 334, 336) is provided. In another example, access for tiers of users to components, resource sets, and/or resources may be mutually exclusive.

Components 322, 324 may be deployed to user tiers 350, 360 (or individual users and/or developers). In some examples, deployment may be throttled, based on any variety of factors (stability, security, efficiency, resource deadlocks, etc.). For example, deployment of an update may be throttled based on failures encountered by one or more other users. Once resources are deployed, the health of the cloud application 310 may further be verified according to any suitable criteria (data integrity, stability, security, efficiency, resource deadlocks, etc.), and one or more health reports may be generated at any time, including before or after an update. Health-check endpoints may be used to verify the health of a resource (such as a service) after an update. Additionally, an application health-check endpoint allows a cloud application to self-evaluate the application's own health. Further, compute health may be used to verify that a resource is running. In another example of health checking, storage health may be used to verify that underlying storage used by the cloud application is accessible. In some examples, dependent services health may be used to verify whether dependent resources respond as expected. Additionally, a user may be required to opt-in to request updates for the application. In some examples, the update includes signature data that is compared to other data (e.g., a key) to determine whether the update is legitimate.

The health of a cloud maybe monitored prior to, during, and/or after deployment of an update (e.g., via the health report). Based upon one or more suitable criteria, distribution of one or more updates may be stopped and/or suspended based on the health of the cloud prior to, during, and/or after deployment of the update. For example, an update distributor (e.g., update component 326) may receive a health report associated with a first update to a first cloud and selectively distribute (or not distribute) the first update and/or another update to the first cloud based on the received health report. Additionally or alternatively, the update distributor may selectively distribute (or not distribute) the first update and/or another update to another cloud that may or may not be associated with the first cloud (or other shared or overlapping cloud infrastructure) based on the received health report. The health report may include, for example, update statistics, which are comparable to an update threshold. On condition that the update statistics do not satisfy the update threshold (e.g., the update statistics are below the update threshold), a distribution of the update may be suspended. On the other hand, on condition that the update statistics satisfy the update threshold (e.g., the update statistics are at or above the update threshold), the update may be distributed to apply the update. In some examples, the update distributor may communicate with one or more cloud administrators (e.g., private cloud administrators) for troubleshooting and/or providing update status data, as contact information (e.g., email) may be provided to the update distributor.

Resources may be multi-tenant (utilized by multiple users/developers, even among different user tiers). As components and/or resources are acquired, auto-install may be utilized in some examples. Additionally, resource publisher information is available in some examples for contacting such publishers for troubleshooting purposes.

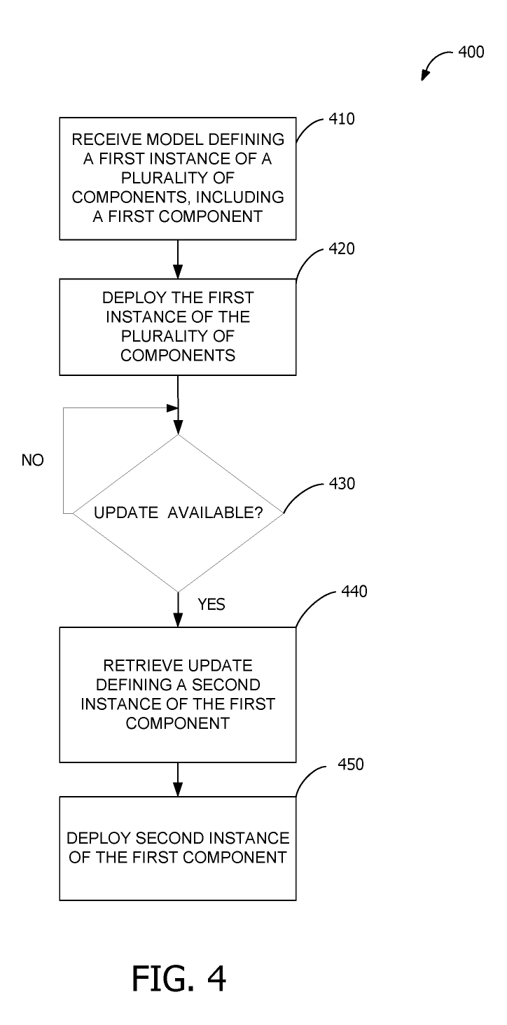

FIG. 4 is a flowchart of an example method 400 of deploying an updated template to a component. At 410, the cloud application 310 receives a model 320 that includes one or more components 322, 324 (e.g., a first component) and at least one update component 326. The model 320 may define a first instance of the components. At 420, the cloud application 310 deploys the first instance of the plurality of components 322, 324, which may include deployment to one or more resources 332, 334, 336, 342, 344, and 346 and/or one or more of resource sets 330, 340.

At 430, a check is performed by the update component 326 to see if an update 328 to the cloud application 310 is available. The update component 326 may be updated by any suitable interface, such as with a powershell script. If no update 328 is available, the update component 326 may check again later. For example, the update component 326 may check for an update after a predetermined period of time has elapsed since a previous check. In some examples, the check is performed at regular intervals, whereas other examples utilize other time intervals (where each time intervals may be separately specified and/or irregular). Other examples may await a request from a user or system to receive updated statistics, or some combination of automatic and manual checking.

At 440, if at least one update 328 is available, the update component 326 retrieves the update 328 containing an updated version of the model 320 (e.g., a template in some examples). The template 320 may define a second instance of one or more cloud components 322, 324. At 450, an updated version of at least one cloud component 322 is deployed to update and/or replace the current version of the cloud component 322. In some examples, the updated version may be deployed on condition that the updated version satisfies one or more predetermined conditions or requirements. For example, it may be determined whether one or more conditions (e.g., prerequisites) are satisfied and/or a version associated with the first instance may be compared with a version associated with the second instance.

In some examples, update distribution options may be used to specify the distribution ring and distribution ranks of the update in order to control and/or throttle the update's release. The distribution ring may be used to further specify a staggered release, where the staggering is by any suitable criteria. The distribution ring may also allow for specifying which versions of the application that the update applies to and selectively update only the specified versions (or exclude some versions in other examples). In some examples, update distribution can be automatically stopped if installation reports from other applications indicate that update installation is not successful. Some examples also perform a test deployment(s) of an update prior to a wide release. Some examples further provide for preventing automatic installation of updates and rather configure an auto-update service running in a private cloud to require an explicit approval of updates before such updates are distributed.

In some examples, a first update distributor associated with a first private cloud (e.g., update component 326) may process one or more updates for the first private cloud separate from distribution services beyond the first private cloud. For example, the first update distributor may be configured to distribute one or more updates to the first private cloud, another update distributor (e.g., a second update distributor) may be configured to distribute one or more updates to another private cloud different from the first private cloud, and/or yet another update distributor (e.g., a third update distributor) may be configured to distribute one or more updates to a public cloud. In this manner, the first private cloud may be configured to selectively receive (or not receive) updates from the first update distributor, the second update distributor, and/or the third update distributor.

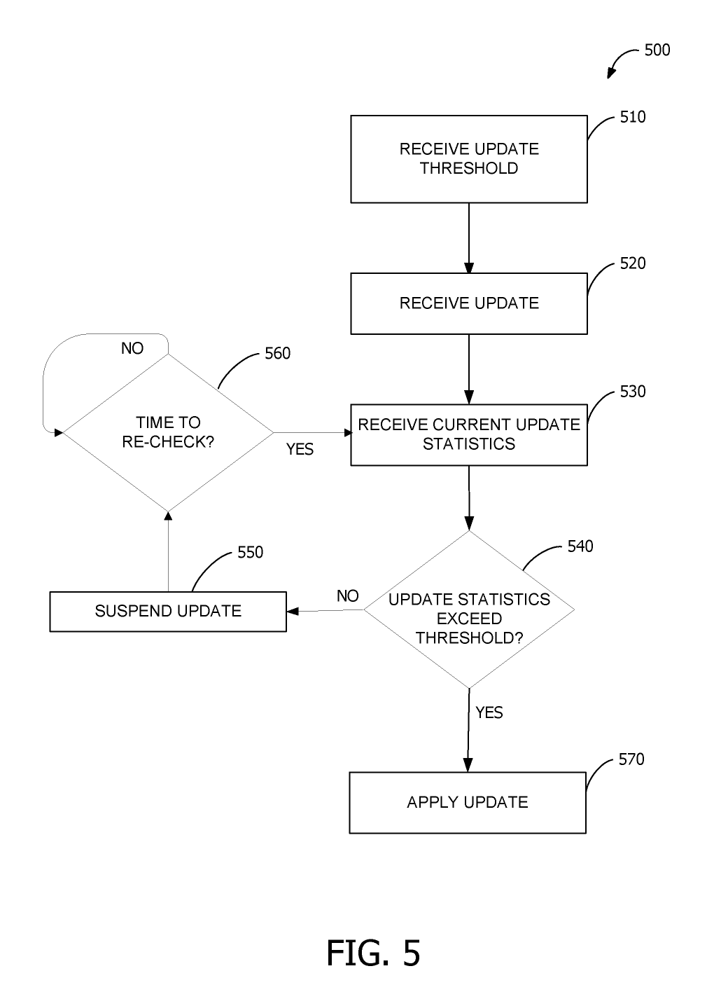

FIG. 5 is a flowchart of an example method 500 of managing updates with a distribution ring. At 510, a cloud application 310 (or an update component 326, for example) receives a threshold pertaining to one or more updates 328. A distribution ring may be set up, for example, as a threshold that utilizes any suitable type of threshold (including any number and/or type of criteria and/or rules) restricting and/or permitting the application of updates. In some examples, application registration input specifying a distribution ring and/or contact data may be received. Statistics about an update may be analyzed, whether the statistics are contained as metadata within the update, or whether the statistics are received from another source. One example of update statistics may pertain to the stability of updates, where only updates at or above a predetermined stability rating are permitted to be applied. Another example may pertain to an update adoption rate, which may be measured by comparing how many instances of an update have actually been applied versus all (or a subset of) instances where the update may be applied. Still another example pertains to a stability rating of an update, where the distribution ring restricts updates not having at least a predetermined stability rating. Further, any suitable combination of rules and/or criteria may be utilized, and may include compound rules and/or criteria. For example, an update exceeding a predetermined security rating criterion may in turn modify (e.g., lower) an adoption percentage criterion (or vice versa).

At 520, an update is received or requested. At 530, statistics about the update are received. As described above, the statistics may be contained within the update itself (e.g., metadata) or may be provided from another source. At 540, the update statistics are compared against one or more update thresholds in the distribution ring. If the threshold is satisfied (e.g., if the update statistics exceed the threshold), then the update may be applied at 570, for example where the update's adoption level exceeds (or at least meets) the threshold adoption level. Alternatively, if the update's statistics are below (or fail to exceed in other examples) a threshold update adoption level, then the update may be suspended (or cancelled in other examples) at 550.

Once an update has been suspended at 550, a check may be periodically performed at 560 to determine if a predetermined period of time has elapsed to check for more up-to-date statistics for the update. In some examples, the check is performed at regular intervals, whereas other examples utilize other time intervals (where each time intervals may be separately specified and/or irregular). Other examples may await a request from a user or system to receive updated statistics, or some combination of automatic and manual checking.

At 560, once the requisite time has elapsed, current (or recent, with the recency being specifiable as its own threshold in some examples) statistics about the update may be retrieved and/or received at 530. Some examples may only allow statistics to be received and/or retrieved at 530 (and/or compared to the threshold at 540) if the statistics differ from the previous version (or differ by more than a threshold difference, in some examples).

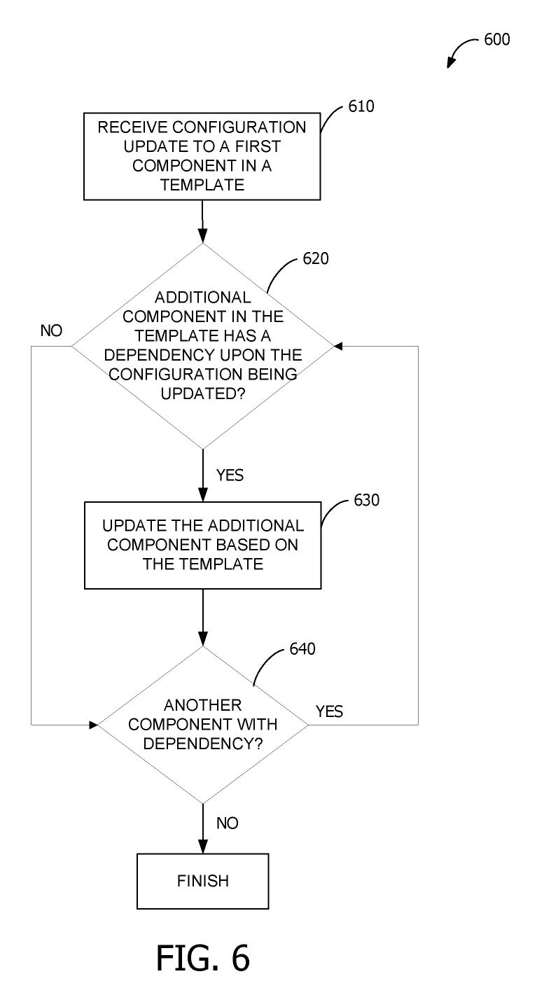

FIG. 6 is a flowchart of an example method 600 of dependency updating within a template. At 610, a configuration update for at least one component 322 in a model 320 (e.g., a first component) is received. The configuration update may pertain, for example, to an updated password for a resource 322 such as a database.

At 620, a check is performed to determine whether an additional component 324 in the model 320 has a dependency upon the configuration being updated. For example, another component 324 in the model 320 may have a dependency upon the modified configuration (e.g., the updated database password). The configuration update may pertain, for example, to a resource 332 or a resource set 330. If the additional component 324 does not have a dependency, then a check is performed to see if there is another component with a dependency at 640.

If there is a dependency at 620, then at 630 the additional component 324 is updated to reflect the change to the first component 322. A configuration change may propagate to any or all components affected by the change, and may also be stored within the template. The propagation may apply to the same or different resource(s) between components and/or with respect to the same component. At 640, a check is performed to determine whether another component also has a dependency related to the configuration change. If so, the next component is checked by returning to 620.

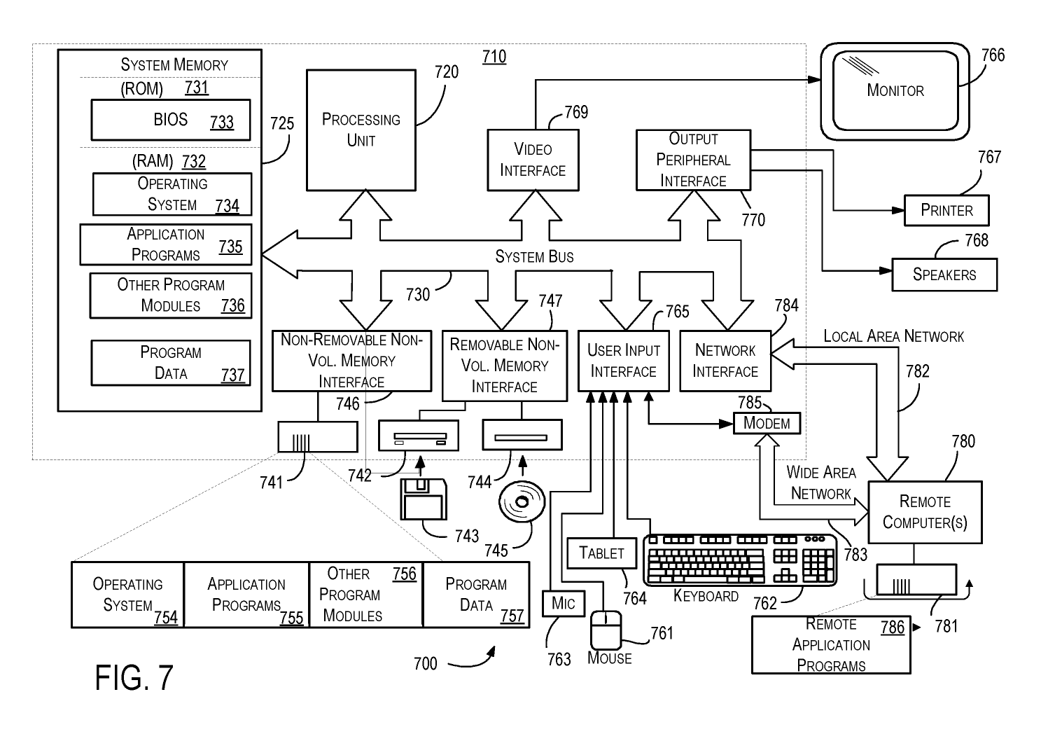

FIG. 7 is a block diagram of an example operating environment 700 that may be used to deploy an updated template to a cloud component. The operating environment 700 is only one example of a computing and networking environment and is not intended to suggest any limitation as to the scope of use or functionality of the disclosure. The operating environment 700 should not be interpreted as having any dependency or requirement relating to any one or combination of components illustrated in the example operating environment 700.

The disclosure is operational with numerous other computing and networking environments or configurations. The operating environment 700 may represent a group of processing units or other computing devices. Additionally, any computing device described herein may be configured to perform any operation described herein including one or more operations described herein as being performed by another computing device.

While some examples of the disclosure are illustrated and described herein with reference to the operating environment 700 being in a cloud-computing environment (see, e.g., FIG. 1), aspects of the disclosure are operable with any computing device that executes instructions to implement the operations and functionality associated with the operating environment 700. With reference to FIG. 7, an example system for implementing various aspects of the disclosure may include a general purpose computing device in the form of a computer 710. Components of the computer 710 may include, but are not limited to, a processing unit 720, a system memory 725, and a system bus 730 that couples various system components including the system memory 725 to the processing unit 720. The system bus 730 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. In some examples, the processing unit 720 represents an implementation of analog techniques to perform the operations described herein. For example, the operations may be performed by an analog computing device and/or a digital computing device.

The system memory 725 includes any quantity of media associated with or accessible by the processing unit 720. For example, the system memory 725 may include computer storage media in the form of volatile and/or nonvolatile memory such as read only memory (ROM) 731 and random access memory (RAM) 732. The ROM 731 may store a basic input/output system 733 (BIOS) that facilitates transferring information between elements within computer 710, such as during start-up. The RAM 732 may contain data and/or program modules that are immediately accessible to and/or presently being operated on by processing unit 720. For example, the system memory 725 may store computer-executable instructions, communication data, authentication data, application data, and other data.

The processing unit 720 may be programmed to execute the computer-executable instructions for implementing aspects of the disclosure, such as those illustrated in the figures (e.g., FIGS. 4-6). By way of example, and not limitation, FIG. 7 illustrates operating system 734, application programs 735, other program modules 736, and program data 737. The processing unit 720 includes any quantity of processing units, and the instructions may be performed by the processing unit 720 or by multiple processors within the operating environment 700 or performed by a processor external to the operating environment 700.

The system memory 725 may include one or more components that enable the operating environment 700 to perform one or more functions. For example, upon programming or execution of these components, the operating environment 700 and/or processing unit 720 is transformed into a special purpose microprocessor or machine. For example, an interface module, when executed by the processing unit 720, causes the processing unit 720 to receive a template defining an instance of a plurality of components for a distributed cloud application, and deploy the instance of the plurality of components; and an update module, when executed by the processing unit 720, causes the processing unit 720 to determine whether an update to a distributed cloud application is available, and, in response to determining that the update is available, retrieve a template associated with the update. Although the processing unit 720 is shown separate from the system memory 725, examples of the disclosure contemplate that the system memory 725 may be onboard the processing unit 720 such as in some embedded systems.

The computer 710 may also include other removable/non-removable, volatile/nonvolatile computer storage media. By way of example only, FIG. 7 illustrates a hard disk drive 741 that reads from or writes to non-removable, nonvolatile magnetic media, a magnetic disk drive 742 that reads from or writes to a removable, nonvolatile magnetic disk 743 (e.g., a floppy disk, a tape cassette), and an optical disk drive 744 that reads from or writes to a removable, nonvolatile optical disk 745 (e.g., a compact disc (CD), a digital versatile disc (DVD)). Other removable/non-removable, volatile/nonvolatile computer storage media that may be used in the example operating environment include, but are not limited to, flash memory cards, digital video tape, solid state RAM, solid state ROM, and the like. The hard disk drive 741 may be connected to the system bus 730 through a non-removable memory interface such as interface 746, and magnetic disk drive 742 and optical disk drive 744 may be connected to the system bus 730 by a removable memory interface, such as interface 747.

The drives and their associated computer storage media, described above and illustrated in FIG. 7, provide storage of computer-readable instructions, data structures, program modules and other data for the computer 710. In FIG. 7, for example, hard disk drive 741 is illustrated as storing operating system 754, application programs 755, other program modules 756 and program data 757. Note that these components may either be the same as or different from operating system 734, application programs 735, other program modules 736, and program data 737. Operating system 754, application programs 755, other program modules 756, and program data 757 are given different numbers herein to illustrate that, at a minimum, they are different copies.

The computer 710 includes a variety of computer-readable media. Computer-readable media may be any available media that may be accessed by the computer 710 and includes both volatile and nonvolatile media, and removable and non-removable media.

By way of example, and not limitation, computer-readable media may include computer storage media and communication media. Computer storage media includes volatile and nonvolatile, removable and non-removable media implemented in any method or technology for storage of information such as computer-readable instructions, data structures, program modules or other data. ROM 731 and RAM 732 are examples of computer storage media. Computer storage media are tangible and mutually exclusive to communication media. Computer storage media for purposes of this disclosure exclude signals per se. Computer storage media includes hard disks, flash drives, solid state memory, RAM, ROM, electrically erasable programmable read-only memory (EEPROM), flash memory or other memory technology, CDs, DVDs, or other optical disk storage, magnetic cassettes, magnetic tape, magnetic disk storage or other magnetic storage devices, or any other medium which may be used to store the desired information and which may accessed by the computer 710. Computer storage media are implemented in hardware and exclude carrier waves and propagated signals. Any such computer storage media may be part of computer 710.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

A user may enter commands and information into the computer 710 through one or more input devices, such as a pointing device 761 (e.g., mouse, trackball, touch pad), a keyboard 762, a microphone 763, and/or an electronic digitizer 764 (e.g., tablet). Other input devices not shown in FIG. 7 may include a joystick, a game pad, a controller, a satellite dish, a camera, a scanner, an accelerometer, or the like. These and other input devices may be coupled to the processing unit 720 through a user input interface 765 that is coupled to the system bus 730, but may be connected by other interface and bus structures, such as a parallel port, game port or a universal serial bus (USB).

Information, such as text, images, audio, video, graphics, alerts, and the like, may be presented to a user via one or more presentation devices, such as a monitor 766, a printer 767, and/or a speaker 768. Other presentation devices not shown in FIG. 7 may include a projector, a vibrating component, or the like. These and other presentation devices may be coupled to the processing unit 720 through a video interface 769 (e.g., for a monitor 766 or a projector) and/or an output peripheral interface 770 (e.g., for a printer 767, a speaker 768, and/or a vibration component) that are coupled to the system bus 730, but may be connected by other interface and bus structures, such as a parallel port, game port or a USB. In some examples, the presentation device is integrated with an input device configured to receive information from the user (e.g., a capacitive touch-screen panel, a controller including a vibrating component). Note that the monitor 766 and/or touch screen panel may be physically coupled to a housing in which the computer 710 is incorporated, such as in a tablet-type personal computer.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include one or more LANs 782 and one or more WANs 783, but may also include other networks. Such networking environments are commonplace in offices, enterprise-wide computer networks, intranets and the Internet.

When used in a LAN networking environment, the computer 710 is coupled to the LAN 782 through a network interface or adapter 784. When used in a WAN networking environment, the computer 710 may include a modem 785 or other means for establishing communications over the WAN 783, such as the Internet. The modem 785, which may be internal or external, may be connected to the system bus 730 via the user input interface 765 or other appropriate mechanism. A wireless networking component such as including an interface and antenna may be coupled through a suitable device such as an access point or peer computer to a LAN 782 or WAN 783. In a networked environment, program modules depicted relative to the computer 710, or portions thereof, may be stored in the remote memory storage device. By way of example, and not limitation, FIG. 7 illustrates remote application programs 786 as residing on memory storage device 781. It may be appreciated that the network connections shown are examples and other means of establishing a communications link between the computers may be used.

The block diagram of FIG. 7 is merely illustrative of an example system that may be used in connection with one or more examples of the disclosure and is not intended to be limiting in any way. Further, peripherals or components of the computing devices known in the art are not shown, but are operable with aspects of the disclosure. At least a portion of the functionality of the various elements in FIG. 7 may be performed by other elements in FIG. 7, or an entity (e.g., processor, web service, server, applications, computing device, etc.) not shown in FIG. 7.

The subject matter described herein enables a computing device to deploy an updated template to a cloud component. For example, one or more updates may be applied to multiple machines or resources in a distributed environment. In this way, one or more cloud components may be updated in a calculated and systematic manner for increased performance.

Although described in connection with an example computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. Examples of the disclosure may also be practiced in distributed computing environments where tasks are performed by remote processing devices that are linked through a communications network. In a distributed computing environment, program modules may be located in local and/or remote computer storage media including memory storage devices.

The examples illustrated and described herein as well as examples not specifically described herein but within the scope of aspects of the disclosure constitute example means for model-driven updates. For example, the elements illustrated in FIGS. 1, 2, 3, and/or 7, such as when encoded to perform the operations illustrated in FIGS. 4, 5, and/or 6 constitute at least an example means for receiving a template defining an instance of a plurality of components for a distributed cloud application; an example means for deploying an instance of a plurality of components; an example means for determining whether an update to a distributed cloud application is available; and an example means for retrieving a template associated with an update.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

Alternatively or in addition to the other examples described herein, examples include any combination of the following:
receiving a template defining an instance of a plurality of components for a distributed cloud application;
deploying an instance of one or more components;
determining whether an update to a distributed cloud application is available;
retrieving a template associated with an update;
determining whether an update satisfies one or more predetermined conditions;
determining a health of a distributed cloud application;
generating one or more health reports;
throttling a deployment of an instance of one or more components;
receiving a declarative model defining a first tier of users and a second tier of users;
receiving, within an update, signature data that is compared to other data to determine whether the update is legitimate;
determining a first condition defined by a declarative model for deploying an instance of a plurality of components to be available to a tier of users;
allocating a resource during a deployment of an instance of a component to change a service topology associated with a distributed cloud application;
adding a component based on a template;
removing a component based on a template;
receiving an update including update statistics;
suspending an update;
deploying an update;
applying an update;
receiving application registration input specifying a distribution ring and contact data;
an interface component configured to receive a template defining an instance of a plurality of components for a distributed cloud application;
an interface component configured to deploy an instance of a plurality of components;
an update component configured to determine whether an update to a distributed cloud application is available;
an update component configured to retrieve a template associated with an update;
an update component configured to determine a health of a distributed cloud application;
an update component configured to generate one or more health reports;
an update component configured to propagate a configuration update for a first component to a second component;
an update component configured to receive an update including update statistics;
an update component configured to suspend an update;
an update component configured to apply an update;
an update component configured to compare refreshed update statistics;
an update component configured to keep an update suspended;
an update component configured to receive a declarative model defining a first tier of users and a second tier of users; and
an update component configured to determine a condition defined by a declarative model for deploying an instance of one or more components to be available to a tier of users.

In some examples, the operations illustrated in the drawings may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

What is claimed is:

1. A computer-implemented method comprising:
receiving a model defining a first instance of a plurality of components for a distributed cloud application, the plurality of components including a first component and an update component;
deploying the first instance of the plurality of components;
determining, at the update component, whether an update to the distributed cloud application is available;
in response to determining that the update is available, retrieving a template associated with the update, the template defining a second instance of the first component; and
deploying the second instance of the first component.

2. The computer-implemented method of claim 1, further comprising:
determining, at the update component, a health of the distributed cloud application; and
based on the health of the distributed cloud application, generating a report.

3. The computer-implemented method of claim 1, wherein deploying the first instance of the plurality of components comprises throttling the deployment of the first instance of the plurality of components.

4. The computer-implemented method of claim 1, wherein deploying the second instance of the first component comprises throttling the deployment of the second instance of the first component.

5. The computer-implemented method of claim 1, further comprising comparing signature data associated with the update to other data to determine whether the update is legitimate.

6. The computer-implemented method of claim 1, wherein deploying the second instance of the first component comprises:
receiving a declarative model defining a first tier of users and a second tier of users;
determining a first condition defined by the declarative model for deploying the second instance of the first component to be available to the first tier of users, wherein the second instance of the first component is deployed to a first set of machines such that the distributed cloud application is available to the first tier of users; and
determining a second condition defined by the declarative model for deploying the second instance of the first component to be available to second tier of users, wherein the second instance of the first component is deployed to a second set of machines such that the distributed cloud application is available to the second tier of users.

7. The computer-implemented method of claim 1, wherein deploying the second instance of the first component comprises allocating a new resource during the deployment of the second instance of the first component to change a service topology associated with the distributed cloud application.

8. A computer storage medium having computer-executable instructions embodied thereon, wherein, upon execution by at least one processor, the computer-executable instructions cause the processor to:
receive a first template defining a first instance of a plurality of components for a distributed cloud application, the plurality of components including a first component and an update component;
deploy the first instance of the plurality of components;
determine, at the update component, whether an update to the distributed cloud application is available;
in response to determining that the update is available, retrieve a second template associated with the update, the second template defining a second instance of the first component; and
deploy the second instance of the first component.

9. The computer storage medium of claim 8, wherein, upon execution by the at least one processor, the computer-executable instructions further cause the processor to add or remove a component based on the retrieved second template.

10. The computer storage medium of claim 8, wherein, upon execution by the at least one processor, the computer-executable instructions further cause the processor to:
determine, at the update component, a health of the distributed cloud application; and
based on the health of the distributed cloud application, generate a report.

11. The computer storage medium of claim 8, wherein, upon execution by the at least one processor, the computer-executable instructions further cause the processor to receive application registration input specifying a distribution ring and contact data.

12. The computer storage medium of claim 8, wherein, upon execution by the at least one processor, the computer-executable instructions further cause the processor to:
receive a declarative model defining a first tier of users and a second tier of users;
determine a first condition defined by the declarative model for deploying the second instance of the first component to be available to the first tier of users, wherein the second instance of the first component is deployed to a first set of machines such that the distributed cloud application is available to the first tier of users; and
determine a second condition defined by the declarative model for deploying the second instance of the first component to be available to second tier of users, wherein the second instance of the first component is deployed to a second set of machines such that the distributed cloud application is available to the second tier of users.

13. The computer storage medium of claim 8, wherein, upon execution by the at least one processor, the computer-executable instructions further cause the processor to:
receive update statistics;
suspend the update based upon the update statistics being below an update threshold; and
apply the update based upon the update statistics satisfying the update threshold.

14. The computer storage medium of claim 8, wherein, upon execution by the at least one processor, the computer-executable instructions further cause the processor to allocate a new resource during the deployment of the second instance of the first component to change a service topology associated with the distributed cloud application.

15. A computing system comprising:
an interface module configured to receive a first template defining a first instance of a plurality of components for a distributed cloud application, and deploy the first instance of the plurality of components, the plurality of components including a first component and an update component; and
an update module configured to determine whether an update to the distributed cloud application is available, and retrieve a second template associated with the update, the second template defining a second instance of the first component.

16. The computing system of claim 15, wherein the update module is configured to determine a health of the distributed cloud application, and, based on the health of the distributed cloud application, generate a report.

17. The computing system of claim 15, wherein the update module is configured to propagate a configuration update for the first component to a second component in the plurality of components based upon a dependency between the first component and the second component.

18. The computing system of claim 15, wherein the update module is configured to receive update statistics associated with an update to a first cloud system, compare the update statistics to an update threshold, suspend the update on condition that the update statistics do not satisfy the update threshold, and distribute the update to a second cloud system to apply the update at the second cloud system on condition that the update statistics satisfy the update threshold.

19. The computing system of claim 18, wherein the update module is configured to compare refreshed update statistics upon suspending the update, keep the update suspended on condition that the refreshed update statistics do not satisfy the update threshold, and apply the update on condition that the refreshed update statistics satisfies the update threshold.

20. The computing system of claim 15, wherein the update module is configured to:
receive a declarative model defining a first tier of users and a second tier of users;
determine a first condition defined by the declarative model for deploying the second instance of the first component to a first set of machines such that the distributed cloud application is available to the first tier of users; and
determine a second condition defined by the declarative model for deploying the second instance of the first component to a second set of machines such that the distributed cloud application is available to the second tier of users.
